(19) United States
(12) Patent Application Publication
(10) Pub. No.: US 2026/0044894 A1
(43) Pub. Date: Feb. 12, 2026

(54) TRANSFER OF OFFCHAIN AND ONCHAIN ASSETS BASED ON ACQUISITION OF CORRESPONDING ASSETS

(71) Applicant: Unstoppable Domains, Inc., Las Vegas, NV (US)

(72) Inventors: Lisa Seacat DeLuca, Bozeman, MT (US); Matthew Gould, Atlanta, GA (US)

(21) Appl. No.: 18/798,090

(22) Filed: Aug. 8, 2024

(51) Int. Cl. G06Q 40/04; H04L 9/00

(52) U.S. Cl. CPC G06Q 40/04; H04L 9/50; G06Q 2220/00; H04L 2209/56

(57) ABSTRACT

According to a present invention embodiment, a system for transferring assets of a computer environment receives a request to obtain a first asset of the computer environment on a first type of system for a user. The first asset on the first type of system corresponds to a second asset of the computer environment on a second type of system. The system determines acquisition of the second asset on the second type of system by the user. The first asset on the first type of system is transferred to the user based on acquisition of the second asset on the second type of system by the user. The first and second types of systems include a centralized system and a decentralized system. Embodiments of the present invention further include a method and computer program product for transferring assets of a computer environment in substantially the same manner described above.

### TECHNICAL FIELD

Present invention embodiments relate to networking and, more specifically, to transfer of offchain assets (e.g., Web2 domains or domain names, ICANN domains or domain names, Domain Name System (DNS) domains or domain names, assets of other centralized domain systems, etc.) based on acquisition of corresponding onchain assets (e.g., non-fungible tokens (NFTs), blockchain domains or domain names, etc.), and transfer of onchain assets (e.g., non-fungible tokens (NFTs), blockchain domains or domain names, etc.) based on acquisition of corresponding offchain assets (e.g., Web2 domains or domain names, ICANN domains or domain names, Domain Name System (DNS) domains or domain names, assets of other centralized domain systems, etc.).

### BACKGROUND

### Discussion of the Related Art

There exists a trend to bridge worlds of real assets, such as physical and digital goods, with blockchain technology. For example, a non-fungible token (NFT) of a blockchain is a crypto type asset with each token being unique. An NFT may represent items, such as digital art, music, or video game items, and may also represent real assets (e.g., physical goods, tickets, etc.). A transfer of ownership of the NFT may be used to indicate transfer of ownership of the corresponding real asset.

Web2 generally refers to a version of the web (or Internet) that utilizes a centralized Domain Name System (DNS) to translate domain names into corresponding Internet Protocol (IP) addresses in order to access a web site. In contrast, Web3 generally refers to a decentralized version of the web (or Internet) based on blockchains and peer-to-peer networks.

A user may obtain a Web3 domain (represented by a non-fungible token (NFT)), and desire to obtain the corresponding Web2 domain. However, ownership of Web2 and Web3 domains are separable. In other words, transfer of the Web3 domain does not necessarily transfer ownership of the Web2 domain which may provide operational and other inconsistencies.

### SUMMARY

According to one embodiment of the present invention, a system for transferring assets of a computer environment comprises one or more memories and at least one processor coupled to the one or more memories. The system receives a request to obtain a first asset of the computer environment on a first type of system for a user. The first asset on the first type of system corresponds to a second asset of the computer environment on a second type of system. The system determines acquisition of the second asset on the second type of system by the user. The first asset on the first type of system is transferred to the user based on acquisition of the second asset on the second type of system by the user. The first and second types of systems include a centralized system and a decentralized system. Embodiments of the present invention further include a method and computer program product (e.g., including one or more computer readable media with instructions executable by one or more processors) for transferring assets of a computer environment in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a block diagram of an example computing device according to an embodiment of the present invention.

FIG. 3 is a flowchart of a method of registering a name or other identifier for an onchain asset (e.g., Web3, blockchain, etc.) based on a name or other identifier for an offchain asset (e.g., Web2, Domain Name System (DNS), etc.) according to an embodiment of the present invention.

FIG. 4 is a flowchart of a method of transferring an offchain asset based on acquisition of an onchain asset according to an embodiment of the present invention.

FIG. 5 is a schematic illustration of an example graphical user interface for managing onchain and offchain assets according to an embodiment of the present invention.

FIG. 6 is a schematic illustration of an example graphical user interface for updating information for an offchain asset according to an embodiment of the present invention.

FIG. 7 is a flowchart of a method of transferring an onchain asset based on acquisition of an offchain asset according to an embodiment of the present invention.

### DETAILED DESCRIPTION

There exists a trend to bridge worlds of real assets, such as physical and digital goods, with blockchain technology. For example, a non-fungible token (NFT) of a blockchain is a crypto type asset with each token being unique. An NFT may represent items, such as digital art, music, or video game items, and may also represent real assets (e.g., physical goods, tickets, etc.). A transfer of ownership of the NFT may be used to indicate transfer of ownership of the corresponding real asset.

Web2 generally refers to a version of the web (or Internet) that utilizes a centralized Domain Name System (DNS) to translate domain names into corresponding Internet Protocol (IP) addresses in order to access a web site. Domain Name System (DNS) creates a set of one or more records when a domain name is registered. DNS records (or text files) reside in DNS servers and provide information pertaining to a domain name including an associated IP address and request handling.

In contrast, Web3 generally refers to a decentralized version of the web (or Internet) based on blockchains and peer-to-peer networks.

In order to bridge the gap between Web2 and Web3, an embodiment of the present invention enables an offchain (e.g., Web2, etc.) domain name to be tokenized so that there is an onchain representation. For example, a non-fungible token (NFT) may be created on a blockchain representing the offchain domain name. This enables a user who also owns the offchain domain name to send and receive digital assets to that domain name (e.g., tokens or cryptocurrencies) and be able to leverage the benefits of Web3 technology, such as fast digital asset transfer and proof of ownership.

However, the user may obtain a tokenized (or onchain) version of an offchain domain name, and the offchain version of the domain name is not transferred to the new owner. In this case, it may be difficult to provide a refund or otherwise determine ownership of both the tokenized (onchain) and the offchain domain.

Accordingly, an embodiment of the present invention enables a user to reserve (or assert ownership of) an offchain asset (e.g., Web2 domain or domain name, ICANN domain or domain name, Domain Name System (DNS) domain or domain name, etc.), and ultimately acquire the offchain asset through acquisition of an onchain asset (e.g., Web3 domain or domain name, blockchain domain or domain name, non-fungible token (NFT), etc.). By way of example, the onchain asset may be a non-fungible token (NFT) representing a corresponding onchain version of an offchain domain name (or tokenized version of the offchain domain name). An offchain domain name may be tokenized as an NFT or other onchain representation by a blockchain service or smart contract.

The present invention embodiment honors ownership of an onchain asset to reserve (or assert ownership of) the offchain equivalent of the onchain asset. The onchain asset (e.g., non-fungible token (NFT) representing the tokenized domain name) may serve as a placeholder to reserve (or assert ownership of) the offchain version of an onchain asset. Further, the placeholder may include blockchain signatures (e.g., parties to a transfer each sign a message in respective wallet accounts approving the transfer, etc.). This provides enhanced security for onchain and offchain assets by maintaining the onchain and offchain assets together (e.g., common ownership, etc.), thereby preventing wrongful acquisition of the assets. In other words, a user needs to acquire an onchain asset in order to obtain the corresponding offchain asset.

An embodiment of the present invention may enable a user to reserve (or assert ownership of) an onchain asset (e.g., Web3 domain or domain name, blockchain domain or domain name, non-fungible token (NFT), etc.), and ultimately acquire the onchain asset through acquisition of an offchain asset (e.g., Web2 domain or domain name, ICANN domain or domain name, Domain Name System (DNS) domain or domain name, etc.). The offchain asset may serve as a placeholder to reserve (or assert ownership of) the onchain version of the offchain asset. Further, the placeholder may include blockchain signatures (e.g., parties to a transfer each sign a message in respective wallet accounts approving the transfer, etc.). This provides enhanced security for onchain and offchain assets by maintaining the onchain and offchain assets together (e.g., common ownership, etc.), thereby preventing wrongful acquisition of the assets. In other words, a user needs to acquire an offchain asset in order to obtain the corresponding onchain asset.

Transfer of an onchain or offchain asset may include any action or transaction that provides ownership, rights, registration, and/or any other interest in the onchain or offchain asset. Further, acquiring or obtaining an onchain or offchain asset may include obtaining ownership, rights, registration, and/or any other interest in the onchain or offchain asset.

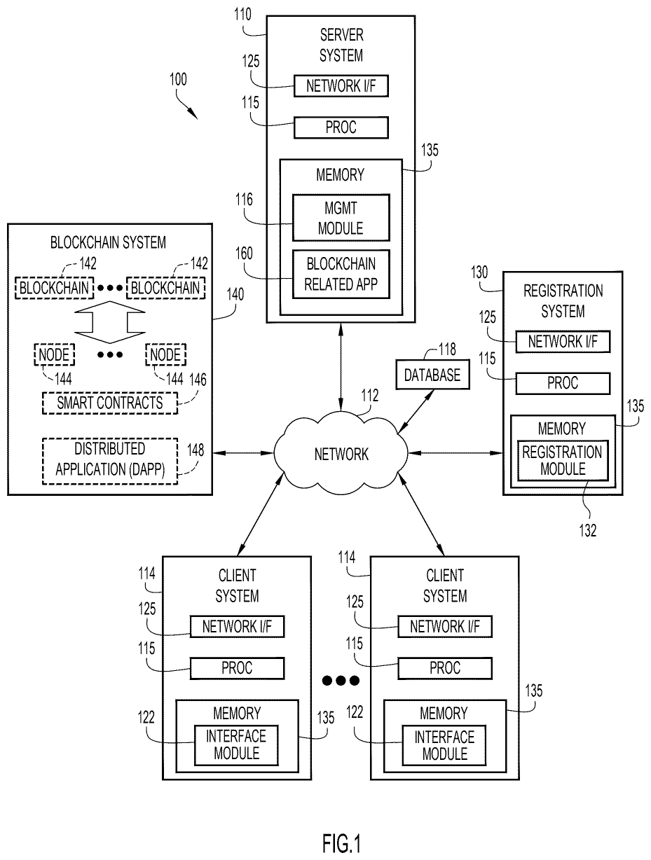

An example environment 100 for use with present invention embodiments is illustrated in FIG. 1. Specifically, environment 100 includes one or more server systems 110, one or more client or end-user systems 114, one or more registration systems 130, and one or more blockchain systems 140 each implementing and maintaining at least one corresponding blockchain 142. Server systems 110, client systems 114, registration systems 130, and/or blockchain systems 140 may be remote from each other and communicate over a network 112. The network may be implemented by any number of suitable communications media (e.g., wide area network (WAN), local area network (LAN), Internet, Intranet, etc.). Alternatively, server systems 110, client systems 114, registration systems 130, and/or blockchain systems 140 may be local to each other, and communicate via any appropriate local communication medium (e.g., local area network (LAN), hardwire, wireless link, Intranet, etc.).

Server systems 110 include a management module 116. Management module 116 may interface with a user via client system 114, and/or may be of the form of an Application Programming Interface (API) to perform onchain and/or offchain asset management (e.g., for domains or other objects, etc.). The management module may process requests from any entities (e.g., user, application, service, computing or other device, etc.).

Client systems 114 may include an interface module 122 to provide a graphical user (e.g., GUI, etc.) or other interface (e.g., command line prompts, menu screens, etc.) that enables users to access server systems 110 and blockchain systems 140 for managing onchain and/or offchain assets (e.g., domains or other objects, etc.). The interface module may include any conventional or other browser to access server systems 110 and blockchain systems 140.

Registration systems 130 include a registration module 132 that registers and manages names or other identifiers for offchain assets (e.g., Web2 domains or domain names, ICANN domains or domain names, Domain Name System (DNS) domains or domain names, etc.). By way of example, the registration system may include a conventional or other DNS server.

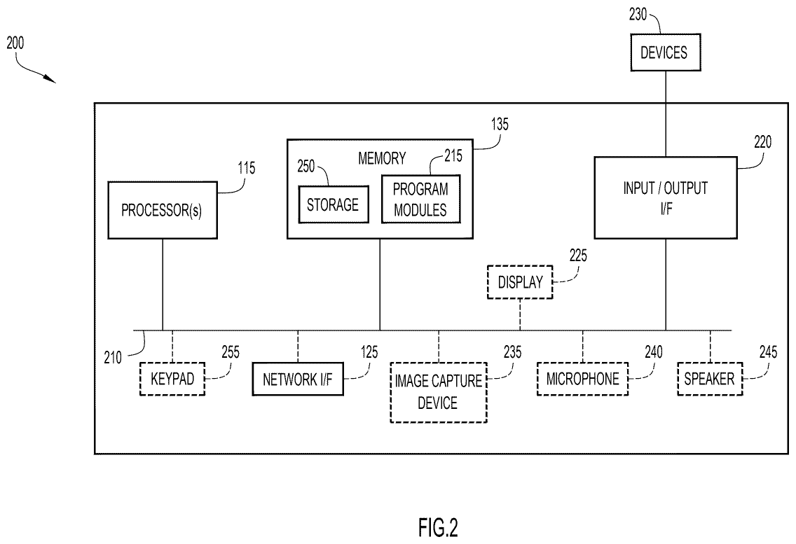

Blockchain systems 140 may each include one or more nodes 144 to implement and maintain at least one corresponding blockchain 142. The nodes may be implemented by any suitable computing devices (e.g., as described below for FIG. 2). The blockchain is generally in the form of a ledger that includes a series of records or blocks chained or linked together. The blockchain is typically managed by a peer-to-peer network (of nodes 144) and used as a distributed ledger. Nodes 144 of the peer-to-peer network communicate and verify new blocks according to a protocol. The peer-to-peer network provides a decentralized approach, where each node has a copy of a blockchain 142. Transactions are transmitted to the peer-to-peer network, where mining nodes (nodes 144) process the transactions. The mining nodes validate a transaction, insert the transaction into a current block, and transmit the block to the other nodes. Blockchain 142 may be implemented by any conventional or other blockchain, and may be a public (e.g., no access restrictions, etc.), private (e.g., restricted access, etc.), or hybrid (e.g., with centralized and decentralized features) blockchain.

Blockchain systems 140 may include one or more distributed or decentralized applications (dApps) 148 to perform various operations (e.g., financial or other transactions or operations related to a blockchain, etc.). In addition, a blockchain 142 may store software (e.g., typically referred to as smart contracts 146) that executes on the blockchain in response to occurrence of pre-defined conditions. The smart contracts may transfer onchain and/or offchain assets as described below. The onchain assets may be associated with the same and/or various different blockchains.

Interface module 122 of client systems 114 may further provide a graphical user (e.g., GUI, etc.) or other interface (e.g., command line prompts, menu screens, etc.) that enables users to access distributed applications (dApps) 148 and/or smart contracts 146 on blockchain systems 140 for performing various operations (e.g., financial or other transactions or operations related to a blockchain, etc.). The interface module may include any conventional or other browser to access the decentralized applications (dApps) of blockchain systems 140. The interface module may natively, or include extensions to, access the decentralized applications (dApps) and/or other components of blockchain system 140. The interface module may provide a user interface to serve as a front end for a decentralized application (dApp) 148, where back end processing for the decentralized application (dApp) is performed on a blockchain system 140. Client systems 114 may further provide reports or notifications pertaining to requests from users (e.g., results of a transaction, transfers of onchain and/or offchain assets, etc.).

Server systems 110 further include one or more blockchain related applications 160 for performing various operations (e.g., transactions or operations related to a blockchain, access asset information based on an associated asset, etc.). Management module 116 and blockchain related applications 160 may be on the same or different server systems 110. The blockchain related application may process requests from any entities (e.g., user, application, service, computing or other device, etc.).

A database or offchain storage system 118 may store various information for a blockchain asset (e.g., blockchain asset information, mappings of blockchain assets to blockchains, blockchain domain content, etc.). The database system may be implemented by any conventional or other database or offchain storage unit (e.g., Interplanetary File System (IPFS), etc.), may be local to or remote from server systems 110, client systems 114, registration systems 130, and/or blockchain systems 140, and may communicate via any appropriate communication medium (e.g., local area network (LAN), wide area network (WAN), Internet, hardwire, wireless link, Intranet, etc.).

Server systems 110, client systems 114, and registration systems 130 may be implemented by any conventional or other computer systems preferably equipped with a display or monitor, a base, optional input devices (e.g., a keyboard, mouse or other input device), and any software for use by present invention embodiments (e.g., server/communications software, blockchain software, management module 116, interface module 122, registration module 132, blockchain related applications 160, etc.). The base may include at least one hardware processor 115 (e.g., microprocessor, controller, central processing unit (CPU), etc.), one or more memories 135, and/or internal or external network interfaces or communications devices 125 (e.g., modem, network cards, etc.)).

Management module 116, interface module 122, registration module 132, smart contracts 146, decentralized applications (dApps) 148, and blockchain related applications 160 may include one or more modules or units to perform the various functions of present invention embodiments described below. The various modules (e.g., management module 116, interface module 122, registration module 132, blockchain related applications 160, etc.) may be implemented by any combination of any quantity of software and/or hardware modules or units, and may reside within memory 135 of the server and/or client systems for execution by a corresponding processor 115. The various modules of the blockchain (e.g., smart contracts 146, decentralized applications (dApps) 148, etc.) may be implemented by any combination of any quantity of software and/or hardware modules or units, and may reside on a blockchain 142 for execution by one or more nodes 144.

An example of a computing device 200 for environment 100 (e.g., implementing server systems 110, client systems 114, registration systems 130, blockchain systems 140, nodes 144, etc.) is illustrated in FIG. 2. The example computing device may perform the functions of present invention embodiments described herein. Computing device 200 may be implemented by any personal or other type of computer or processing system (e.g., desktop, laptop, hand-held device, smartphone or other mobile device, etc.), and may be used for any computing environments (e.g., cloud computing, client-server, network computing, mainframe, stand-alone systems, etc.).

Computing device 200 may include one or more processors 115 (e.g., microprocessor, controller, central processing unit (CPU), etc.), network interface 125, memory 135, a bus 210, and an Input/Output interface 220. Bus 210 couples these components for communication, and may be of any type of bus structure, including a memory bus or memory controller, a peripheral bus, and a processor or local bus using any of a variety of conventional or other bus architectures. Memory 135 is coupled to bus 210 and typically includes computer readable media including volatile media (e.g., random access memory (RAM), cache memory, etc.), non-volatile media, removable media, and/or non-removable media. For example, memory 135 may include storage 250 containing non-removable, non-volatile magnetic or other media (e.g., a hard drive, etc.). The computing device may further include a magnetic disk drive and/or an optical disk drive (not shown) (e.g., CD-ROM, DVD-ROM or other optical media, etc.) connected to bus 210 via one or more data interfaces.

Moreover, memory 135 includes a set of program modules 215 (e.g., corresponding to management module 116, interface module 122, registration module 132, blockchain software (e.g., smart contracts 146, decentralized applications (dApp) 148, blockchain management software, etc.), blockchain related applications 160, network site or service software, etc.) that are configured to perform functions of present invention embodiments described herein. The memory may further include an operating system, at least one application and/or other modules, and corresponding data. These may provide an implementation of a networking environment.

Input/Output interface 220 is coupled to bus 210 and communicates with one or more peripheral or external devices 230 (e.g., a keyboard, mouse or other pointing device, a display, sensing devices, etc.), at least one device that enables a user to interact with computing device 200, and/or any device (e.g., network card, modem, etc.) that enables computing device 200 to communicate with one or more other computing devices. Computing device 200 may communicate with one or more networks (e.g., a local area network (LAN), a wide area network (WAN), a public network (e.g., the Internet), etc.) via network interface 125 coupled to bus 210.

With respect to certain entities (e.g., client system 114, etc.), computing device 200 may further include, or be coupled to, a touch screen or other display 225, a camera or other image capture device 235, a microphone or other sound sensing device 240, a speaker 245 to convey sound, and/or a keypad or keyboard 255 to enter information (e.g., alphanumeric information, etc.). These items may be coupled to bus 210 or Input/Output interface 220 to transfer data with other elements of computing device 200.

Initially, a blockchain (e.g., blockchain 142, etc.) is generally in the form of a ledger that includes a series of records or blocks chained or linked together. Each block includes a hash of the prior block in the blockchain, a timestamp, and transaction information. The hash of the prior block enables the blockchain to be resistant to modification since changes to data in any prior block alter the hash value which propagates to subsequent blocks.

A blockchain is typically managed by a peer-to-peer network and used as a distributed ledger. Nodes of the peer-to-peer network communicate and verify new blocks according to a protocol. The peer-to-peer network provides a decentralized approach, where each node has a copy of the blockchain. Transactions are transmitted to the network, where mining nodes process the transactions. The mining nodes validate a transaction, insert the transaction into a current block, and transmit the block to the other nodes. Various consensus approaches may be used for combining validation results of different mining nodes to determine validity of a transaction (or block).

Users of transactions for the blockchain are authenticated based on cryptographic keys. These keys identify a user and provide access to a user wallet. The user wallet is basically an application or software that enables users to store and access digital assets (e.g., for receiving or sending cryptocurrency or other fungible tokens, non-fungible tokens (NFTs), etc.). For example, a non-fungible token (NFT) is a crypto type asset with each token being unique (and representing items, such as digital art, music, or video game items), whereas fungible tokens (e.g., coins of the same cryptocurrency) have the same value of worth and are exchangeable. Each user is associated with their own private key (e.g., accessible only to the associated user, etc.) and a public key (e.g., typically an address on the blockchain). The private and public keys enable authentication of the user based on digital signatures in order to commence a transaction. The user wallet typically stores the private key.

For example, in order for the user to send cryptocurrency, a message for a transaction is encrypted (or signed) using the private key of the user wallet. The private key enables only the user to control the user wallet. A digital signature is created by encrypting the message with the private key, where the digital signature is used to verify the user and transaction. The message may be decrypted with the corresponding public key of the user wallet. Since the private key is unique to the user, successful decryption of the message with the corresponding public key verifies the message was sent by the user. Once verified, the transaction may be posted to the blockchain, thereby adjusting the user account based on the transaction.

In addition, a blockchain may store software (e.g., smart contracts 146) that executes in response to occurrence of pre-defined conditions. A smart contract is generally software or a program that runs on the blockchain. The code and data for the smart contract reside at a specific address on the blockchain. Non-fungible tokens (NFTs) are controlled by smart contracts that handle transference and verification of ownership of the non-fungible tokens (NFTs). A blockchain may be public (e.g., no access restrictions, etc.), private (e.g., restricted access, etc.), or hybrid (e.g., with centralized and decentralized features).

A blockchain domain name is stored on a blockchain. A blockchain domain name may be a non-fungible token (NFT) domain name that is associated with a non-fungible token (NFT) stored in a user wallet account. The blockchain domain name may be associated with various information (e.g., wallet addresses or accounts, user information (e.g., name, address, email, etc.), data or other access restrictions, etc.). The blockchain domain name is associated with software or smart contracts on the blockchain that may perform various functions (e.g., provide a registry for corresponding wallet addresses, indicate locations of content for the domain (e.g., or a website, etc.) hosted on the blockchain or other system, etc.). In order to access a blockchain domain, the blockchain is accessed to find the record corresponding to the blockchain domain name (which may initiate the corresponding smart contracts for the corresponding functionality). The private key of the user wallet enables the user to have sole control of the blockchain domain (e.g., authenticating operations or transactions for the blockchain domain name similar to the cryptocurrency example described above, etc.). For example, the user may have sole control to perform operations that alter content and/or functionality for the blockchain domain.

An embodiment of the present invention leverages acquisition (or ownership) of onchain assets (e.g., Web3 domains or domain names, blockchain domains or domain names, non-fungible tokens (NFTs), etc.) in order to acquire offchain assets (e.g., Web2 domains or domain names, ICANN domains or domain names, Domain Name System (DNS) domains or domain names, etc.). The present invention embodiment transfers the offchain asset (e.g., Web2 domain or domain name, ICANN domain or domain name, Domain Name System (DNS) domain or domain name, etc.) to a user based on acquisition (or ownership) of the corresponding onchain asset. For example, an offchain asset (e.g., Web2 domain or domain name, ICANN domain or domain name, Domain Name System (DNS) domain or domain name, etc.) may be obtained using ownership of a corresponding onchain asset (e.g., Web3 domain or domain name, blockchain domain or domain name, non-fungible token (NFT), etc.), thereby enabling the onchain asset ownership to reserve and be used to acquire the offchain asset. Transfer of an onchain or offchain asset may include any action or transaction that provides ownership, rights, registration, and/or any other interest in the onchain or offchain asset. Further, acquiring or obtaining an onchain or offchain asset may include obtaining ownership, rights, registration, and/or any other interest in the onchain or offchain asset.

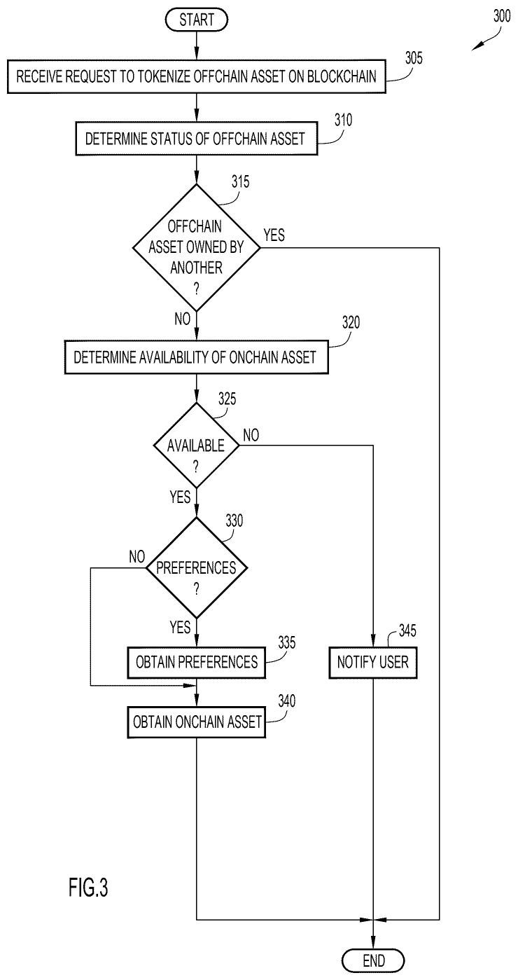

A method 300 of registering a name or other identifier for an onchain asset (e.g., Web3, blockchain, etc.) based on a name or other identifier for an offchain asset (e.g., Web2, Domain Name System (DNS), etc.) (e.g., via management module 116, registration module 132, smart contract 146, distributed application (dApp) 148, blockchain related application 160, server system 110, client system 114, registration system 130, and/or blockchain system 140) according to an embodiment of the present invention is illustrated in FIG. 3. Initially, a user may register, or desire to register, a name or other identifier of an offchain asset (e.g., Web2, ICANN, Domain Name System (DNS), etc.) for an onchain asset (e.g., Web3, blockchain, non-fungible token (NFT), etc.) via management module 116 to obtain the offchain asset based on acquisition (or ownership) of the onchain asset. An asset may include any item or object associated with a computer or network environment (e.g., a domain, a domain name, a set of records, an object that points to a set of records, a non-fungible token (NFT), non-fungible token (NFT) domain names, a fungible token, a wallet address, email or other service, communication entity, etc.). An onchain asset may include any asset residing on, or supported by, a blockchain or other decentralized system (e.g., Web3 asset, asset of a decentralized system, asset of a partial or hybrid decentralized system, etc.). An offchain asset may include any asset residing on, or supported by, a centralized system or a system with centralized control (e.g., Web2, Domain Name System (DNS), system other than a decentralized system described above, etc.). The name or other identifier for the offchain and onchain assets may include a name portion and an optional extension (e.g., “name.e1”, etc.). Alternatively, the name or other identifier may include the name portion without the extension. The name portion and extension may each include any quantity of terms, words, tokens, or arrangements of any quantity of any types of elements (e.g., alphanumeric or other characters, symbols, numbers, etc.). A user may include, or be associated with, any type of entity (e.g., individual, company, organization, decentralized autonomous organization (DAO), etc.).

Management module 116 receives a request for the name or other identifier of the offchain asset to tokenize (or create a corresponding non-fungible token (NFT) for) the offchain asset on a blockchain at operation 305. The management module may receive and process requests from any entities (e.g., user, application, service, computing or other device, client system 114, etc.). The management module performs a look-up of the name of the offchain asset at operation 310 to determine registration/ownership of the offchain asset by another user (e.g., indicating unavailability of the offchain asset). By way of example, the offchain asset may include an offchain domain name (e.g., Web2, Domain Name System (DNS), etc.), and management module 116 requests information (e.g., DNS records, etc.) for the offchain domain name from registration system 130. The information from the registration system indicates registration/ownership or availability of the offchain asset.

When the offchain asset is not registered/owned by another user as determined at operation 315, management module 116 determines availability of the name of the offchain asset for an onchain asset at operation 320. In other words, management module determines availability of an onchain equivalent of the offchain asset. For example, the management module (e.g., via blockchain related application 160) accesses an intended blockchain 142 for the onchain version (e.g., via a blockchain system 140), and performs a look-up for the name of the offchain asset on the blockchain. Absence of a record on the blockchain for the name indicates the name for the offchain asset (or onchain version) is available on the blockchain. Further, management module 116 may perform a look-up for the name (e.g., on a blockchain, marketplace, etc.) to determine availability of the onchain asset for transfer from another user. The intended blockchain may be selected by a user, and the name for the look-up may include the name portion of the name of the offchain asset (e.g., with the same extension, a corresponding extension for the intended blockchain, etc.).

When an onchain representation of the offchain asset is available as determined at operation 325, payment and other preferences may be provided or selected for acquiring the onchain version (e.g., tokenizing the offchain asset on the blockchain). The options or preferences may include payment to acquire the onchain representation, an intended blockchain or other system to publish or mint the onchain version, a smart contract for the transaction, etc. When preferences are required as determined at operation 330, management module 116 obtains the preferences at operation 335. The preferences may be stored offchain in database system 118, or received from an administrator.

The name for the onchain version is acquired at operation 340. For example, management module 116 (e.g., via blockchain related application 160, corresponding smart contract 146, and/or distributed application (dApp) 148) publishes or mints the name for the onchain version (e.g., represented by a non-fungible token (NFT)) on a corresponding blockchain, and/or transfers the on-chain asset from a current owner to the user (e.g., places the onchain asset in a user wallet account). The acquisition of the onchain version may be performed based on any required preferences. This may be accomplished by management module 116 (e.g., via blockchain related application 160, corresponding smart contract 146, and/or distributed application (dApp) 148) providing a transaction to the blockchain indicating acquisition of the onchain version (or NFT) by the user. In addition, various information for the onchain version (e.g., user information, asset information, wallet information, etc.) may be stored onchain and/or in offchain storage (e.g., database system 118, etc.).

The onchain version may be linked to the offchain version based on the corresponding name or other identifier. For example, an onchain or offchain record may be created or modified to include an identifier for the offchain asset (e.g., an offchain domain name to be linked, etc.). The onchain asset (e.g., non-fungible token (NFT) representing the tokenized domain name) may serve as a placeholder to reserve rights to acquire (or assert ownership of) the offchain version of the onchain asset at a later time. Further, the placeholder may include blockchain signatures (e.g., parties to a transfer each sign a message in respective wallet accounts approving the transfer, etc.). This provides enhanced security for onchain and offchain assets by maintaining the onchain and offchain assets together (e.g., common ownership, etc.), thereby preventing wrongful acquisition of the assets. In other words, a user needs to acquire an onchain asset in order to obtain the corresponding offchain asset.

When the onchain asset is not available based on the look-up (e.g., an onchain representation of the offchain asset is already owned by the user or by another user that is not making the onchain asset available for transfer) as determined at operations 325, management module 116 alerts or notifies the user at operation 345. The notification may indicate ownership information for the onchain version of the offchain asset (e.g., the user or other user owning the onchain asset, etc.), and may be presented on a client system 114 (e.g., via interface module 122, etc.).

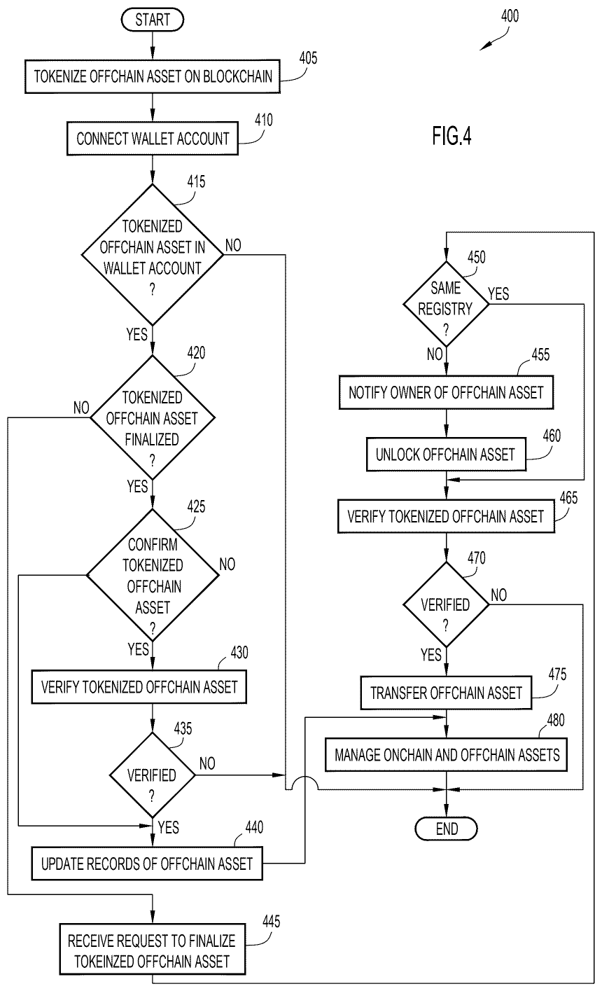

A method 400 of transferring an offchain asset based on acquisition of an onchain asset (e.g., via management module 116, registration module 132, smart contract 146, decentralized application (dApp) 148, blockchain related application 160, server system 110, client system 114, registration system 130, and/or blockchain system 140) according to an embodiment of the present invention is illustrated in FIG. 4. Initially, management module 116 tokenizes an offchain asset (e.g., Web2 domain or domain name, ICANN domain or domain name, Domain Name System (DNS) domain or domain name, etc.) on a blockchain at operation 405 in substantially the same manner described above (FIG. 3). The tokenization may include minting or publishing a non-fungible token (NFT) representing the offchain asset on the blockchain, and/or transferring the NFT from a current owner to the user (e.g., places the onchain asset in a user wallet account). A user may include, or be associated with, any type of entity (e.g., individual, company, organization, etc.). Transfer of an onchain or offchain asset may include any action or transaction that provides ownership, rights, registration, and/or any other interest in the onchain or offchain asset. Further, acquiring or obtaining an onchain or offchain asset may include obtaining ownership, rights, registration, and/or any other interest in the onchain or offchain asset.

By way of example, method 400 is described with respect to an onchain asset including a Web3 or blockchain domain or domain name (e.g., represented by a non-fungible token (NFT)) and an offchain asset including a Web2, ICANN, or Domain Name Service (DNS) domain or domain name. However, any onchain and offchain assets may be transferred in substantially the same manner described below.

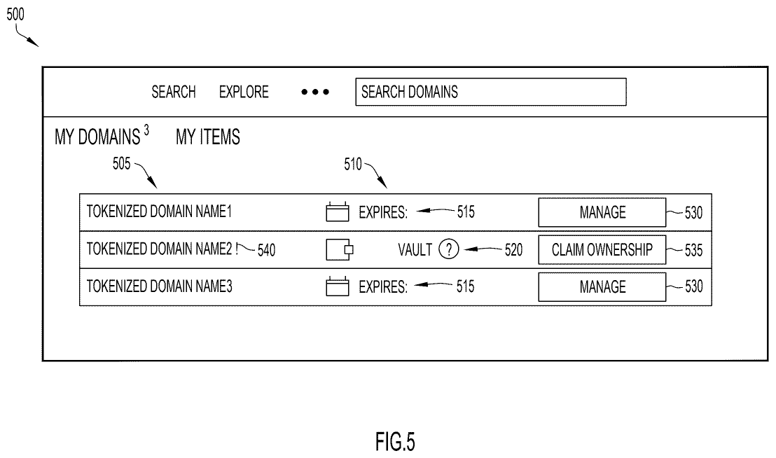

A user with a wallet account of one or more onchain assets (e.g., tokenized domain names, etc.) desires to acquire (or assert ownership) of a corresponding offchain asset (e.g., offchain domain or domain name). Management module 116 may provide a user interface to enable management of onchain and offchain assets, and to acquire (or assert ownership) of corresponding offchain assets as described below (FIG. 5). Alternatively, an application programming interface (API) may be used by other entities (e.g., other systems, devices, applications, etc.) to communicate with management module 116 for acquiring (or asserting ownership of) corresponding offchain assets.

Management module 116 connects or accesses a user wallet account at operation 410. The wallet account may be accessed based on credentials provided by the user, and includes the onchain assets acquired by the user. Management module 116 examines the onchain assets of the wallet account and determines a presence of tokenized versions of offchain assets within the wallet account. For example, the onchain assets of the wallet account may be determined by searching transactions on a corresponding blockchain (e.g., via management module 116, distributed application 148, and/or blockchain related application 160) indicating acquisition of onchain assets by the wallet account. The presence of tokenized offchain assets may be determined based on the names and/or extensions of the onchain assets and/or records of the onchain assets indicating corresponding offchain versions.

When a tokenized offchain asset is present in the wallet account as determined at operation 415, management module 116 determines a status of the tokenized offchain asset as finalized (e.g., the corresponding offchain asset has been acquired). When the tokenized offchain asset is not finalized as determined at operation 420, the user may be prompted to request that the offchain asset be finalized or acquired (e.g., an actuator or prompt presented on a user interface, etc.).

Management module 116 receives a request to finalize or acquire the corresponding offchain asset at operation 445 (e.g., actuation of an actuator on the user interface, authorization from a prompt, etc.). Management module 116 determines the registry of the offchain asset and the registry for the offchain asset intended by the user to determine a presence of a transfer of the offchain asset between different registries. The registry of the offchain asset may determined by management module 116 performing a look-up (e.g., via registration system 130, a public database, etc.) to determine a current registry of the offchain asset. The intended registry for the offchain asset may be determined based on the registry for the onchain asset (e.g., the onchain and offchain assets are to be on the same registry), user provided information, etc.

When the current and intended registries for the offchain asset are different as determined at operation 450, the current owner of the offchain asset needs to authorize or unlock the offchain asset on the current registry for transfer to the user on another registry. Accordingly, management module 116 (e.g., via registration module 132 and registration system 130) determines contact and/or other information for the current owner of the offchain asset and sends a notification to the current owner of the offchain asset (e.g., text message, email, chat, etc.) indicating the transfer at operation 455. The notification may request that the current owner unlock (or authorize transfer of) the offchain asset. In addition, the management module may send a notification to the user (e.g., text message, email, chat, etc.) indicating that the current owner has been notified.

The offchain asset is unlocked (or authorized for transfer) at operation 460. For example, management module 116 may be authorized by the current owner and unlock the offchain asset (e.g., via registration module 132 and registration system 130). Further, the current owner may unlock (or authorize transfer of) the offchain asset (e.g., via registration module 132 and registration system 130). The unlocking or authorization permits access and modification of the records of the offchain asset to enable the transfer.

When the current and intended registries for the offchain asset are the same as determined at operation 450, or once the offchain asset is unlocked at operation 460, management module 116 verifies acquisition (or ownership) of the onchain asset by the user at operation 465. For example, the user may sign a message with the same wallet account containing the onchain asset (or tokenized offchain asset) to confirm acquisition of the onchain asset by the user. By way of example, signing of the message in a crypto wallet account (e.g., custodied, self-custody, etc.) generates a digital signature of the message based on the private key of the wallet account. The signed message or digital signature is decrypted for verification (e.g., by an add-on or plug-in of interface module 122 of client system 114) based on a public key (e.g., blockchain address, etc.) corresponding to the wallet account. Since the private key is unique to the wallet account, successful decryption of the message with the corresponding public key verifies the message was sent by the user. A response may be provided to the management module (e.g., from the add-on or plug-in of interface module 122) indicating a result of the decryption of the signed message.

The onchain asset (e.g., non-fungible token (NFT) representing the tokenized domain name) serves as a placeholder to reserve (or assert ownership of) the offchain version of an onchain asset. This provides enhanced security for onchain and offchain assets by maintaining the onchain and offchain assets together (e.g., common ownership, etc.), thereby preventing wrongful acquisition of the assets. In other words, a user needs to acquire an onchain asset in order to obtain the corresponding offchain asset. When the user has not acquired the onchain asset, acquisition of the corresponding offchain asset is prevented and the process terminates.

Further, the placeholder may include blockchain signatures from each of the entities involved in the transfer (e.g., entities to the transfer (e.g., user, current owner, etc.) each sign a message in respective wallet accounts approving the transfer, etc.). For example, the user and current owner may each sign a message in their respective onchain wallet accounts in substantially the same manner described above. By way of example, signing of the messages in the wallet accounts generates digital signatures of the messages based on the private key of the respective wallet account. The signed messages or digital signatures are decrypted for verification based on a public key (e.g., blockchain address, etc.) corresponding to the wallet account. Successful decryption of the messages with the corresponding public keys verifies the messages were sent by the entities. This provides enhanced security for onchain and offchain assets by maintaining the onchain and offchain assets together (e.g., common ownership, etc.), thereby preventing wrongful acquisition of the assets. When the signatures are not valid, acquisition of the corresponding offchain asset is prevented and the process terminates.

When the acquisition of the onchain asset is verified as determined at operation 470, management module 116 transfers the offchain asset to the user at operation 475. For example, management module 116 (e.g., via registration module 132 and registration system 130) may modify an ownership record of the offchain asset. By way of example, Domain Name System (DNS) records for the offchain asset or domain may be modified to indicate a new interest or ownership by the user. Transfer of ownership of the offchain asset may include updating a public database of offchain asset or domain information (e.g., WhoIs, etc.).

Further, management module 116 (e.g., via registration module 132 and registration system 130) modifies the access authority to enable the user to access the records of the offchain asset. By way of example, registration module 132 may modify one or more (e.g., Domain Name System (DNS)) records containing access and other information to enable the user to access the offchain asset records. The management module (e.g., via registration module 132 and registration system 130) may further determine contact and/or other information for the prior owner of the offchain asset and send a notification (e.g., text message, email, chat, etc.) to the prior owner of the offchain asset (e.g., user, registrar, etc.) of the transfer.

The offchain and onchain versions may be linked based on the name or other identifier. For example, management module 116 (e.g., via registration module 132 of registration system 130) may set a record associated with the offchain asset to indicate the onchain representation. By way of example, a Domain Name System (DNS) canonical name or other record may be created or modified to include an identifier for the onchain asset (e.g., onchain domain name, wallet address, etc.).

In addition, management module 116 (e.g., via distributed application (dApp) 148 and/or blockchain related application 160) may set or update records associated with the onchain asset to indicate information for the offchain asset. For example, an onchain or offchain record may be created or modified to include an identifier for the offchain asset (e.g., an offchain domain name to be linked, IP address, registry, etc.).

Once the onchain and offchain representations are acquired, transactions may be conducted (e.g., via management module 116 and/or blockchain related application 160) using the names for the onchain or offchain assets. For example, the information in the record for the offchain asset may be used to resolve data for the onchain representation (e.g., a user may send cryptocurrency to an offchain asset (based on an associated record indicating the onchain asset), etc.). The transaction may be analyzed to determine the actions, underlying system, and the corresponding representation needed for that system. By way of example, when the transaction is for an onchain representation (or domain) for an onchain system using an offchain representation (or domain), a lookup of the Domain Name System (DNS) canonical name or other record associated with the offchain representation (e.g., Web2/offchain/DNS version of the onchain domain) is performed to obtain the onchain representation for conducting the transaction. A similar approach may be used for offchain transactions using onchain representations.

Further, transactions conducted for an onchain or offchain representation may automatically be applied to the linked (offchain or onchain) representation. By way of example, selling an offchain representation also sells the linked onchain representation (and vice versa), transferring the onchain representation also transfers the linked offchain representation (and vice versa), making available for auction the onchain representation also makes the linked offchain representation available (and vice versa), purchasing an offchain representation brand new also purchases the linked onchain representation (and vice versa), taking out a loan may apply to the linked representations or be conducted using one of the linked representations, extending expiration of (or renewing) an offchain representation extends (or renews) the registration for a linked onchain representation (and vice versa), and/or transferring an offchain domain to a new registrar (in the case of domains) transfers the onchain domain to the new registrar (or vice versa) or the transfer may be conducted using one of the linked representations.

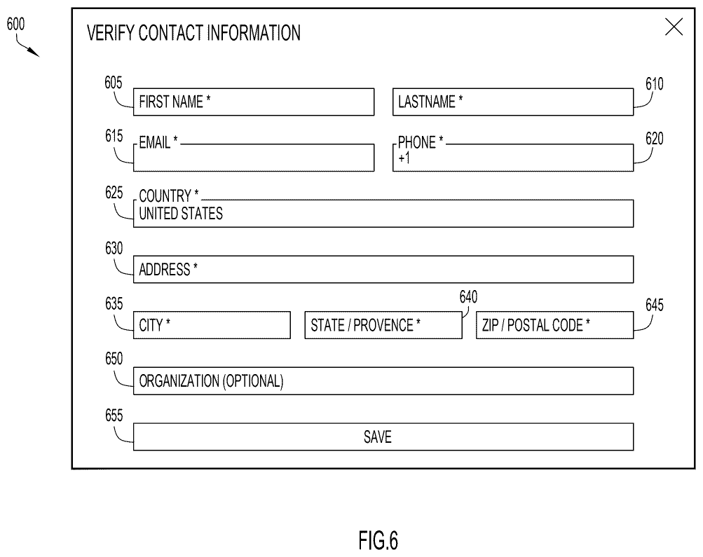

Management module 116 (e.g., via registration module 132 of registration system 130) may further update information for records of the offchain asset (e.g., with new user information, for compliance, etc.). Management module 116 may present a user interface (e.g., FIG. 6) on a client system 114 to obtain information from the user. The information is provided to registration system 130 for updating records of the offchain asset.

When the tokenized offchain asset is finalized as determined at operation 420, the acquisition (or ownership) of the onchain asset by the user may be confirmed. When confirmation is to be performed (e.g., based on a parameter, pre-configured, etc.) as determined at operation 425, the acquisition (or ownership of) the onchain asset by the user is verified at operation 430. For example, the user may sign a message with the same wallet account containing the onchain asset (or tokenized offchain asset) to confirm acquisition of the onchain asset by the user. By way of example, signing of the message in a crypto wallet account (e.g., custodied, self-custody, etc.) generates a digital signature of the message based on the private key of the wallet account. The signed message or digital signature is decrypted for verification (e.g., by an add-on or plug-in of interface module 122 of client system 114) based on a public key (e.g., blockchain address, etc.) corresponding to the wallet account. Since the private key is unique to the wallet account, successful decryption of the message with the corresponding public key verifies the message was sent by the user. A response may be provided to the management module (e.g., from the add-on or plug-in of interface module 122) indicating a result of the decryption of the signed message.

When the acquisition of the onchain asset is verified as determined at operation 435, management module 116 (e.g., via registration module 132 of registration system 130) updates information for records of the offchain asset (e.g., with new user information, for compliance, etc.) at operation 440. Management module 116 may present a user interface (e.g., FIG. 6) on a client system 114 to obtain information from the user. The information is provided to registration system 130 for updating records of the offchain asset.

Once the offchain asset is acquired at operation 475, or updated information is provided at operation 440, the onchain and offchain assets of the user may be managed (e.g., viewed, renewed, acquire corresponding onchain or offchain assets, etc.) by management module 116 (e.g., via a user interface of FIG. 5) at operation 480.

The process may terminate when a tokenized offchain asset is not present in the wallet account as determined at operation 415, the tokenized offchain asset is not acquired or owned by the user (or not verified) as determined at operations 435 or 470, or after management of the onchain and offchain assets at operation 480.

An example graphical user interface 500 for managing onchain and offchain assets according to an embodiment of the present invention is illustrated in FIG. 5. Initially, a user may obtain an offchain asset based on acquisition (or ownership) of a corresponding onchain asset in substantially the same manner described above. By way of example, the offchain asset may include a centralized domain name (e.g., Web2 domain name, ICANN domain name, Domain Name System (DNS) domain name, etc.) and the corresponding onchain asset may include a tokenized version of the offchain asset.

User interface 500 may be presented to a user on a client system 114 (e.g., via interface module 122, etc.). Management module 116 may perform a look-up (e.g., via blockchain system 140) in substantially the same manner described above to identify onchain and corresponding offchain assets of the user.

Management module 116 provides the identified onchain (or tokenized) assets on user interface 500. The user interface includes a table with rows for each asset, and columns or fields including a domain field 505 for the domain name and a status field 510. The status field indicates a status of the corresponding domain name, including expiration dates 515 and storage location 520 (e.g., vault, etc.). Each row for an asset further includes a corresponding actuator to perform actions. For example, rows with tokenized domain names (e.g., TOKENIZED DOMAIN NAME1 and TOKENIZED DOMAIN NAME3 as viewed in FIG. 5) that have been finalized (or corresponding offchain domain names acquired) may include a manage actuator 530 that enables management of the onchain and offchain assets (e.g., view, renew, update records of onchain or offchain assets, etc.). Rows with tokenized domain names (e.g., TOKENIZED DOMAIN NAME 2 as viewed in FIG. 5) that have not been finalized (or the corresponding offchain domain name has not been acquired) may include an actuator 535 to acquire (or obtain ownership of) the offchain asset in substantially the same manner described above.

User interface 500 may include any type of visual or other indicator to indicate a status of a tokenized (onchain) asset (e.g., whether or not the corresponding offchain asset has been acquired, etc.). For example, a tokenized domain name that has not been finalized (e.g., TOKENIZED DOMAIN NAME 2 as viewed in FIG. 5) may have an indicator 540 (e.g., an exclamation point as viewed in FIG. 5) to indicate the corresponding offchain asset has not been acquired. However, any type of visual or other indicator may be used. By way of example, the tokenized assets may be color coded on the user interface to indicate a status (e.g., a first color may indicate that the corresponding offchain assets have been acquired, while a second color may indicate that the corresponding offchain asset has not been acquired, etc.). Further, the tokenized assets may be associated with any visual effects, characters, and/or symbols to indicate a status of the asset (e.g., bold, underline, font size, font color, asterisks, exclamation points, text, etc.).

Accordingly, a user may view their assets and enable acquisition of offchain assets for the corresponding tokenized versions that are onchain.

An example graphical user interface 600 for updating information for an offchain asset according to an embodiment of the present invention is illustrated in FIG. 6. By way of example, user interface 600 obtains user information, but may be used to obtain any desired information for an offchain asset.

Initially, user interface 600 may be presented to a user on a client system 114 (e.g., via interface module 122, etc.) in response to a transfer of an offchain asset as described above. User interface 600 includes a plurality of fields to obtain contact and other information for a user acquiring an offchain asset. By way of example, a first name field 605 receives a first name of the user, while a last name field 610 receives a user last name. An email field 620 receives an email address, while address fields 625, 630, 635, 640, and 645 are for address information for the user and respectively receive the country, street address, city, state, and zip code. Organization field 650 receives a name of an organization of the user, if applicable.

A user may enter the requested information in the appropriate fields and actuate a save actuator 655 to update the information for the offchain asset. Management module 116 sends the information from user interface 600 to registration system 130 to update the information for the offchain asset.

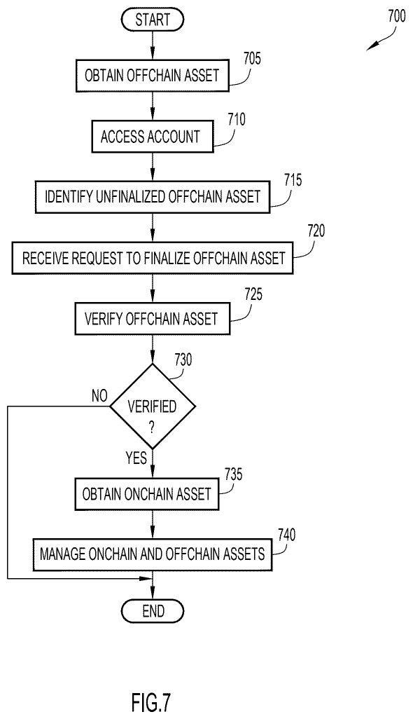

Acquisition of an offchain asset (e.g., offchain domain or domain name, etc.) may be used as a placeholder to reserve (or assert ownership) of an onchain tokenized version of the offchain asset. A method 700 of transferring an onchain asset based on acquisition of an offchain asset (e.g., via management module 116, registration module 132, smart contract 146, decentralized application (dApp) 148, blockchain related application 160, server system 110, client system 114, registration system 130, and/or blockchain system 140) according to an embodiment of the present invention is illustrated in FIG. 7. Initially, management module 116 obtains an offchain asset (e.g., Web2 domain or domain name, ICANN domain or domain name, Domain Name System (DNS) domain or domain name, etc.) at operation 705 in substantially the same manner described above. A user may include, or be associated with, any type of entity (e.g., individual, company, organization, etc.). The offchain asset may serve as a placeholder to reserve (or assert ownership of) the onchain version of an offchain asset. Further, the placeholder may include blockchain signatures (e.g., parties to a transfer each sign a message in respective wallet accounts approving the transfer, etc.).

By way of example, method 700 is described with respect to an onchain asset including a Web3 or blockchain domain or domain name (e.g., represented by a non-fungible token (NFT)) and an offchain asset including a Web2, ICANN, or Domain Name Service (DNS) domain or domain name. However, any onchain and offchain assets may be transferred in substantially the same manner described below. Transfer of an onchain or offchain asset may include any action or transaction that provides ownership, rights, registration, and/or any other interest in the onchain or offchain asset. Further, acquiring or obtaining an onchain or offchain asset may include obtaining ownership, rights, registration, and/or any other interest in the onchain or offchain asset.

A user with an account with a registrar of one or more offchain assets (e.g., offchain domain names, etc.) desires to acquire (or assert ownership) of a tokenized onchain version of an offchain asset. Management module 116 may provide a user interface to enable management of onchain and offchain assets, and to acquire (or assert ownership) of corresponding onchain asset (e.g., similar to FIG. 5). Alternatively, an application programming interface (API) may be used by other entities (e.g., other systems, devices, applications, etc.) to communicate with management module 116 for acquiring (or asserting ownership of) corresponding onchain assets.

Management module 116 connects or accesses a user account (e.g., via registration module 132 and registration system 130) at operation 710. The account may be accessed based on credentials provided by the user, and includes the offchain assets acquired by the user. Management module 116 identifies a status of an offchain asset as unfinalized (e.g., the onchain version has not been acquired) at operation 715. For example, the management module (e.g., via blockchain related application 160) accesses an intended blockchain 142 for the onchain version (e.g., via a blockchain system 140), and performs a look-up for the name of the offchain asset on the blockchain. Absence of a record on the blockchain for the name indicates the name for the offchain asset (or onchain version) is available on the blockchain. Further, management module 116 may perform a look-up for the name (e.g., on a blockchain, marketplace, etc.) to determine availability of the onchain asset for transfer from another user. The intended blockchain may be selected by a user, and the name for the look-up may include the name portion of the name of the offchain asset (e.g., with the same extension, a corresponding extension for the intended blockchain, etc.).

The user may be prompted to request that the offchain asset be finalized or the onchain version be acquired (e.g., an actuator or prompt presented on a user interface, etc.). Management module 116 receives a request to finalize the offchain asset (or acquire the onchain asset) at operation 720 (e.g., actuation of an actuator on the user interface, authorization from a prompt, etc.).

Management module 116 verifies acquisition (or ownership) of the offchain asset by the user at operation 725. For example, the management module may perform a look-up of records with ownership information (e.g., Domain Name System (DNS) records, public database, etc.) for the offchain asset (e.g., via registration module 132 and registration system 130) to confirm the user is listed in the records as the owner of the offchain asset.

The offchain asset (e.g., a Web2, ICANN, or Domain Name Service (DNS) domain or domain name, etc.) serves as a placeholder to reserve (or assert ownership of) an onchain version of the offchain asset. This provides enhanced security for onchain and offchain assets by maintaining the onchain and offchain assets together (e.g., common ownership, etc.), thereby preventing wrongful acquisition of the assets. In other words, a user needs to acquire an offchain asset in order to obtain the corresponding onchain asset. When the user has not acquired the offchain asset, acquisition of the corresponding onchain asset is prevented and the process terminates.

Further, the placeholder may include blockchain signatures from each of the entities involved in the transfer (e.g., entities to the transfer (e.g., user, current owner, etc.) each sign a message in respective wallet accounts approving the transfer, etc.). For example, the user and current owner may each sign a message in their respective onchain wallet accounts in substantially the same manner described above. By way of example, signing of the messages in the wallet accounts generates digital signatures of the messages based on the private key of the respective wallet account. The signed messages or digital signatures are decrypted for verification based on a public key (e.g., blockchain address, etc.) corresponding to the wallet account. Successful decryption of the messages with the corresponding public keys verifies the messages were sent by the entities. This provides enhanced security for onchain and offchain assets by maintaining the onchain and offchain assets together (e.g., common ownership, etc.), thereby preventing wrongful acquisition of the assets. When the signatures are not valid, acquisition of the corresponding onchain asset is prevented and the process terminates.

When the acquisition of the offchain asset is verified as determined at operation 730, management module 116 transfers the onchain asset to the user at operation 735. For example, management module 116 (e.g., via blockchain related application 160, corresponding smart contract 146, and/or distributed application (dApp) 148) publishes or mints the name for the onchain version (e.g., represented by a non-fungible token (NFT)) on a corresponding blockchain, and/or transfers the on-chain asset to the user (e.g., places the onchain asset in a user wallet account). The acquisition of the onchain version may be performed based on any required preferences. This may be accomplished by management module 116 (e.g., via blockchain related application 160, corresponding smart contract 146, and/or distributed application (dApp) 148) providing a transaction to the blockchain indicating acquisition of the onchain version (or NFT) by the user. In addition, various information for the onchain version (e.g., user information, asset information, wallet information, etc.) may be stored onchain and/or in offchain storage (e.g., database system 118, etc.).

The offchain and onchain versions may be linked based on the name or other identifiers. For example, management module 116 (e.g., via registration module 132 of registration system 130) may set a record associated with the offchain asset to indicate the onchain representation. By way of example, a Domain Name System (DNS) canonical name or other record may be created or modified to include an identifier for the onchain asset (e.g., onchain domain name, wallet address, etc.).

In addition, management module 116 (e.g., via distributed application (dApp) 148 and/or blockchain related application 160) may set or update records associated with the onchain asset to indicate information for the offchain asset. For example, an onchain or offchain record may be created or modified to include an identifier for the offchain asset (e.g., an offchain domain name to be linked, IP address, registry, etc.).

Once the onchain and offchain representations are linked, transactions may be conducted (e.g., via management module 116 and/or blockchain related application 160) using the names for the onchain or offchain assets in substantially the same manner described above.

Once the onchain asset is acquired, the onchain and offchain assets of the user may be managed (e.g., viewed, renewed, acquire corresponding onchain or offchain assets, etc.) by management module 116 at operation 740. For example, a user interface to manage the assets may be substantially similar to user interface 500 of FIG. 5. In this case, the user interface provides a listing of offchain assets with corresponding status indicators, and enables acquisition of the corresponding onchain assets (via actuators) in substantially the same manner described above.

Present invention embodiments may provide various technical and other advantages. For example, present invention embodiments provide enhanced manners of accessing an asset, and enable use of asset identifiers (and access of corresponding assets) across different networks (e.g., DNS and blockchain, etc.). Present invention embodiments enable transactions using any of the corresponding offchain and onchain identifiers or domain names, thereby providing new functionality to an identifier of a network that is absent on that network (e.g., send cryptocurrency to a centralized or Web2 domain name, etc.).

Further, present invention embodiments provide enhanced security for onchain and offchain assets by maintaining the onchain and offchain assets together (e.g., common ownership, etc.) to prevent wrongful acquisition of the assets. Moreover, the acquisition of an (onchain or offchain) asset further reserves the corresponding (offchain or onchain asset) to prevent others from wrongfully obtaining and ransoming that corresponding asset (e.g., cybersquatting, etc.). The acquisition of an asset serves as a placeholder to reserve a corresponding asset. This controls transference of assets on centralized and decentralized systems to certain users for enhanced security, thereby conserving computing resources by preventing wasteful performance of wrongful or fraudulent transactions.

It will be appreciated that the embodiments described above and illustrated in the drawings represent only a few of the many ways of implementing embodiments for transfer of offchain and onchain assets based on acquisition of corresponding assets. In addition, characteristics or features of embodiments of the present invention may be combined in any fashion to provide additional embodiments of the present invention.

The environment of the present invention embodiments may include any number of computer or other processing systems (e.g., client or end-user systems, server systems, blockchain systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, hand-held devices, smartphones or other mobile devices, etc.), and may include any commercially available operating system and any combination of commercially available and custom software (e.g., communications software; server software; software of present invention embodiments (including management module 116, interface module 122, registration module 132, smart contracts 146, decentralized applications (dApps) 148, blockchain related applications 160, etc.); etc.). These systems may include any types of monitors and input devices (e.g., keyboard, mouse, voice recognition, etc.) to enter and/or view information.

It is to be understood that the software of the present invention embodiments (e.g., management module 116, interface module 122, registration module 132, smart contracts 146, decentralized applications (dApps) 148, blockchain related applications 160, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client, server, registration, and blockchain systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments (e.g., management module 116, interface module 122, registration module 132, smart contracts 146, decentralized applications (dApps) 148, blockchain related applications 160, etc.) may be available on a non-transitory computer useable or readable medium (e.g., magnetic or optical mediums, magneto-optic mediums, CD-ROM, DVD, memory devices, etc.) of a stationary or portable computer program product, apparatus, or device for use with stand-alone systems or systems connected by a network or other communications medium. The computer usable or readable medium (or media) may include instructions executable by one or more processors to perform functions of present invention embodiments described herein.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., blockchain asset information, metadata, mappings of blockchain assets to blockchains, preferences, etc.). The database system may be implemented by any conventional or other databases, data stores or storage structures to store information. The database system may be included within or coupled to the server, client, registration, and/or blockchain systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., preferences, results of registration, notifications, domain or web site content, blockchain asset information, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The report may include any information arranged in any fashion, and may be configurable based on rules or other criteria to provide desired information to a user (e.g., blockchain assets, status and/or information of onchain and/or offchain assets, registrations, preferences, etc.).

The present invention embodiments are not limited to the specific tasks or algorithms described above, but may be utilized for transferring any offchain and onchain assets based on acquisition or ownership of any corresponding assets. For example, an offchain asset may be acquired based on acquisition of a corresponding onchain asset. Similarly, an onchain asset may be acquired based on acquisition of a corresponding offchain asset.

An asset may include any item or object associated with a computer or network environment (e.g., a domain, a domain name, a set of records, an object that points to a set of records, a non-fungible token (NFT), non-fungible token (NFT) domain names, a fungible token, a wallet address, email or other service, communication entity, etc.). An onchain asset may include any asset residing on, or supported by, a blockchain or other decentralized system (e.g., Web3 asset, asset of a decentralized system, asset of a partial or hybrid decentralized system, etc.). An offchain asset may include any asset residing on, or supported by, a centralized system or a system with centralized control (e.g., Web2, Domain Name System (DNS), ICANN accredited domain names, system other than a decentralized system described above, etc.). An onchain system may include any blockchain or other decentralized system (e.g., Web3, decentralized system, partial or hybrid decentralized system, etc.), while an offchain system may include any centralized system or system with centralized control (e.g., Web2, Domain Name System (DNS), system other than a decentralized system described above, etc.).

The name or other identifier for the offchain and onchain assets may include a name portion and an optional extension (e.g., “name.e1”, etc.). Alternatively, the name or other identifier may include the name portion without the extension. The name portion and extension may each include any quantity of terms, words, tokens, or arrangements of any quantity of any types of elements (e.g., alphanumeric or other characters, symbols, numbers, etc.).

Any quantity of any parameters, values, or other information may be associated with an asset. The information for an offchain asset may include any information arranged in any fashion (e.g., values for domain records, domain parameters, server names or addresses, etc.). Any information of an offchain asset may be stored for an onchain asset to link the assets. This information may be stored on a blockchain and/or on an offchain data source in any storage item (e.g., record, data object, etc.). The information for an onchain asset may include any information arranged in any fashion (e.g., values for asset attributes, blockchain, wallet address, user/owner information etc.). Any information of an onchain asset may be stored for an offchain asset to link the assets. This information may be stored on a blockchain and/or on an offchain data source in any storage item (e.g., record, data object, etc.). The offchain data source may include any storage structure (e.g., decentralized storage structure or platform, blockchain storage, database, etc.). The asset information may be stored and retrieved based on any information (e.g., based on registered user information (e.g., wallet address, blockchain asset, blockchain domain or user name, user information, etc.).

The onchain assets may be from any desired blockchains. Availability for an onchain asset may be determined by searching any onchain and/or offchain storage for any corresponding records or information indicating existence of the onchain asset on a system. Further, availability for an offchain asset may be determined by searching any onchain and/or offchain storage for any corresponding records or information indicating existence of the offchain asset on a system.

A name of an asset of a system may be used to access any corresponding assets of any other systems. For example, the information for the asset may indicate the information (e.g., names or identifiers, addresses, etc.) of the corresponding assets. The information may be retrieved based on the name of the asset and used to resolve the name of the asset to the location (e.g., system, name, address, etc.) of the corresponding assets on the other systems to access (and/or perform transactions) with respect to those corresponding assets. By way of example, a user may send cryptocurrency (e.g., a loan or other payment) to a Web2 domain name.

A user may include, or be associated with, any type of entity (e.g., individual, company, organization, decentralized autonomous organization (DAO), etc.). Transfer of an onchain or offchain asset may include any action or transaction that provides ownership, rights, registration, and/or any other interest in the onchain or offchain asset. Further, an interest may include ownership, rights, registration, and/or any other stake or share in the onchain or offchain asset. Moreover, acquiring or obtaining an onchain or offchain asset may include obtaining ownership, rights, registration, and/or any other interest in the onchain or offchain asset.

The onchain asset (and offchain asset) may be obtained via any type of transaction. Any suitable proof of acquisition or ownership may be used to prove acquisition or ownership of an asset in order to acquire a corresponding asset (e.g., examine user wallet, examine Domain Name System (DNS) or other records for offchain assets, wallet or other signatures or authorizations, etc.). Acquisition of an asset may reserve a corresponding asset for any time period, and may prevent acquisition of the corresponding asset by another in any fashion (e.g., prevent or deny registration, ownership, interest, rights, etc.). Any type of indicator may be provided for an asset to indicate the corresponding asset is reserved (e.g., in the records for an offchain or onchain asset, non-fungible token (NFT) or other asset in a user wallet, authorization by the parties to a transfer, etc.).

The user interface may include any type of visual or other indicator to indicate a status of an onchain or offchain asset (e.g., whether the corresponding asset has been acquired, etc.). For example, assets may be color coded on the user interface to indicate a status (e.g., a first color may indicate that corresponding onchain and offchain assets have been acquired, while a second color may indicate the corresponding asset has not been acquired, etc.). Further, the assets may be associated with any visual effects, characters, and/or symbols to indicate a status (e.g., bold, underline, font size, font color, asterisks, exclamation points, text, etc.). The visual or other indicator, visual effects, characters, and/or symbols may indicate any status of an asset (e.g., corresponding asset acquired, corresponding asset not acquired, asset valid, asset expired, corresponding asset unlocked/authorized for transfer, asset available for transfer, etc.).

The transfer of the onchain asset may be accomplished via any blockchain or other transaction. For example, a transfer may be accomplished by conducting a transaction on the blockchain to indicate transfer of the onchain asset to a new owner. Further, transfer of the offchain asset may be accomplished by modifying any corresponding records of the offchain asset (e.g., Domain Name System (DNS) records, etc.). Moreover, access to the records of the offchain asset may be accomplished by modifying any corresponding records of the offchain asset (e.g., Domain Name System (DNS) records, etc.), and may be performed in response to transfer of the offchain asset.

Present invention embodiments may be used to transfer or acquire any assets based on acquisition of any corresponding assets. The assets and corresponding assets may be the same or different types of assets, and may be on the same or different types of systems (e.g., centralized, decentralized, etc.).

Having described preferred embodiments of a new and improved system, method, and computer program product for transfer of offchain and onchain assets based on acquisition of corresponding assets, it is believed that other modifications, variations and changes will be suggested to those skilled in the art in view of the teachings set forth herein. It is therefore to be understood that all such variations, modifications and changes are believed to fall within the scope of present invention embodiments as defined by the appended claims.

1. A method of transferring assets of a computer environment comprising:
receiving, via at least one processor, a request to register a centralized domain name of the computer environment on a centralized system for a user, wherein the centralized domain name corresponds to a non-fungible token domain name of the computer environment on a blockchain system;
determining, via the at least one processor, ownership of the non-fungible token domain name on the blockchain system by verifying a message signed in a crypto wallet containing the non-fungible token domain name; and
controlling, via the at least one processor, registration of the centralized domain name to the user on the centralized system by:
registering, via the at least one processor, the centralized domain name to the user on the centralized system and granting access to the user to records on the centralized system for the centralized domain name in response to verifying ownership by the user of the non-fungible token domain name on the blockchain system; and
preventing, via the at least one processor, registration of the centralized domain name to the user on the centralized system in response to the user lacking ownership of the non-fungible token domain name on the blockchain system.

2. (canceled)

3. The method of claim 1, wherein the non-fungible token domain name includes a blockchain domain name.

4. The method of claim 1, further comprising:
receiving, via the at least one processor, a request to register a second non-fungible token domain name of the computer environment on the blockchain system for a second user, wherein the second non-fungible token domain name corresponds to a second centralized domain name on the centralized system;
determining, via the at least one processor, ownership of the second centralized domain name on the centralized system by the second user; and
registering, via the at least one processor, the second non-fungible token domain name on the blockchain system to the second user in response to verifying ownership by the second user of the centralized domain name on the centralized system.

5. (canceled)

6. The method of claim 1, wherein determining ownership comprises:
verifying a message signed by the user in the crypto wallet containing the non-fungible token domain name.

7. The method of claim 1, wherein determining ownership comprises:
verifying signed messages from entities involved with registration of the centralized domain name, wherein the messages are signed by the entities in corresponding onchain wallets.

8. The method of claim 1, wherein determining ownership comprises:
presenting non-fungible token domain names of the computer environment on the blockchain system on a user interface each with an associated indicator indicating a status of acquisition of a corresponding centralized domain name on the centralized system.

9. A computer system for transferring assets of a computer environment comprising:
one or more memories; and
at least one processor coupled to the one or more memories, the at least one processor configured to:
receive a request to register a centralized domain name of the computer environment on a centralized system for a user, wherein the centralized domain name corresponds to a non-fungible token domain name of the computer environment on a blockchain system;
determine ownership of the non-fungible token domain name on the blockchain system by verifying a message signed in a crypto wallet containing the non-fungible token domain name; and
control registration of the centralized domain name to the user on the centralized system by:
registering the centralized domain name to the user on the centralized system and granting access to the user to records on the centralized system for the centralized domain name in response to verifying ownership by the user of the non-fungible token domain name on the blockchain system; and
preventing registration of the centralized domain name to the user on the centralized system in response to the user lacking ownership of the non-fungible token domain name on the blockchain system.

10. (canceled)

11. The computer system of claim 2, wherein the non-fungible token domain name includes a blockchain domain name.

12. The computer system of claim 9, wherein the at least one processor is further configured to:
receive a request to register a second non-fungible token domain name of the computer environment on the blockchain system for a second user, wherein the second non-fungible token domain name corresponds to a second centralized domain name on the centralized system;
determine ownership of the second centralized domain name on the centralized system by the second user; and
register the second non-fungible token domain name on the blockchain system to the second user in response to verifying ownership by the second user of the centralized domain name on the centralized system.

13. (canceled)

14. The computer system of claim 9, wherein determining ownership comprises:
verifying a message signed by the user in the crypto wallet containing the non-fungible token domain name.

15. The computer system of claim 9, wherein determining ownership comprises:
verifying signed messages from entities involved with registration of the centralized domain name, wherein the messages are signed by the entities in corresponding onchain wallets.

16. The computer system of claim 9, wherein determining ownership comprises:
presenting non-fungible token domain names of the computer environment on the blockchain system on a user interface each with an associated indicator indicating a status of acquisition of a corresponding centralized domain name on the centralized system.

17. A computer program product for transferring assets of a computer environment, the computer program product comprising one or more non-transitory computer readable media having instructions stored thereon, the instructions executable by at least one processor to cause the at least one processor to:
receive a request to register a centralized domain name of the computer environment on a centralized system for a user, wherein the centralized domain name corresponds to a non-fungible token domain name of the computer environment on a blockchain system;
determine ownership of the non-fungible token domain name on the blockchain system by verifying a message signed in a crypto wallet containing the non-fungible token domain name; and
control registration of the centralized domain name to the user on the centralized system by:
registering the centralized domain name to the user on the centralized system and granting access to the user to records on the centralized system for the centralized domain name in response to verifying ownership by the user of the non-fungible token domain name on the blockchain system; and
preventing registration of the centralized domain name to the user on the centralized system in response to the user lacking ownership of the non-fungible token domain name on the blockchain system.

18. (canceled)

19. The computer program product of claim 17, wherein the non-fungible token domain name includes a blockchain domain name.

20. The computer program product of claim 17, wherein the instructions further cause the at least one processor to:
receive a request to register a second non-fungible token domain name of the computer environment on the blockchain system for a second user, wherein the second non-fungible token domain name corresponds to a second centralized domain name on the centralized system;
determine ownership of the second centralized domain name on the centralized system by the second user; and
register the second non-fungible token domain name on the blockchain system to the second user in response to verifying ownership by the second user of the centralized domain name on the centralized system.

21. (canceled)

22. The computer program product of claim 17, wherein determining ownership comprises:
verifying a message signed by the user in the crypto wallet containing the non-fungible token domain name.

23. The computer program product of claim 17, wherein determining ownership comprises:
verifying signed messages from entities involved with registration of the centralized domain name, wherein the messages are signed by the entities in corresponding onchain wallets.

24. The computer program product of claim 17, wherein determining ownership comprises:
presenting non-fungible token domain names of the computer environment on the blockchain system on a user interface each with an associated indicator indicating a status of acquisition of a corresponding centralized domain name on the centralized system.
